(19) United States
(12) Patent Application Publication
(10) Pub. No.: US 2009/0101754 A1
(43) Pub. Date: Apr. 23, 2009

(54) Aircraft nose gear control apparatus

(76) Inventor: Charles O'CONNELL, Commerce City, CO (US)

Correspondence Address: WILEY REIN LLP, 1776 K. STREET N.W., WASHINGTON, DC, 20006, US

(21) Appl. No.: 11/907,894

(22) Filed: Oct. 18, 2007

(51) Int. Cl. B64C 25/26

(52) U.S. Cl. 244/102 SL

(57) ABSTRACT

The invention relates to an assembly for controlling the rotational degree of freedom for an aircraft landing gear wheel, which can advantageously be used to prevent damage to the aircraft during taxing. In a general embodiment, an upper connection arm is supported by the descending shaft of the landing gear and a pivoting control arm is affixed to a lower region of the landing gear, and a control lock can be used to connect the connection arm to the control arm in order to restrict the rotation of the wheel to a desired range.

### FIELD OF THE INVENTION

The invention relates to aircraft landing gear and more particularly to a system for conveniently locking and un-locking the degree of rotation in a nose gear turning radius. In a preferred example, an easily replaceable or removable locking device for aircraft landing gear is employed, where the locking device has an engaged position preventing damage to aircraft from over-rotation and a visible locked position indicator. In addition, the locking device has a released position, which permits full or a greater degree of rotational freedom of the nose landing gear. The system can be designed so that aircraft operators or taxiway employees can visually inspect the locking device, and most preferably from inside the aircraft.

### BACKGROUND OF THE INVENTION

In many airport settings, towing and moving of aircraft is often required by ground vehicles due to airport restrictions and space limitations. Commonly used tow tug vehicles attach to the forward landing gear to tow and push the aircraft. However, due to the free rotation usually allowed for the forward gear when on the taxiway, the towing and pushing can cause damage to the gear itself. Moreover, the inability to control the movement of the aircraft during towing or pushing can cause damage to that aircraft.

Potential solutions have come mainly in the design and operation of the taxiways and airports. Furthermore, suggestions based upon powered landing gear are generally not practical for civilian and commuter aircraft. To date, no suggestions have provided a sufficient answer to protecting the aircraft that are easily employed and reliable.

### SUMMARY OF THE INVENTION

In one aspect, the invention addresses the problems noted above and provides specific and general solutions to aircraft landing gear that control wheel rotation in order to prevent damage. In other aspects, the invention comprises an aircraft landing gear orientation locking device to restrict the rotational freedom of the nose gear wheel or wheels. The main stabilizing and control shaft of the landing gear has, at its upper region, an upper shaft connection arm that is connected to the shaft and is capable of being locked to restrict or prevent the arm's rotational movement. A second arm at the lower region of the shaft comprises a control locking arm capable of being positioned to engage the upper arm and being locked to the upper arm so that the upper arm prevents the rotation of the lower arm and thereby prevents the rotation of the wheel. When unlocked, the lower, control locking arm is free to rotate with the turning of the nose gear wheel. A locking device locks the control locking arm to the upper shaft arm. Elements of the locking device can be especially useful in creating easy to use aspects of the invention, and can be designed to indicate immediately upon visual inspection whether the landing gear is in a locked or unlocked position.

In one particularly innovative aspect, the present invention includes an improved aircraft landing gear having a releasable locking rod or pin, which can automatically reposition from an engaged position (where a rotating portion of the landing gear is prevented from rotating) to a released position (where the rotating portion is free to rotate). The automatic repositioning can be in response to excessive side pressure on the landing gear due to tug or tow vehicles and an optional warning indicator can be actuated when the engaged position is released to the free to rotate position.

According to this and other aspects of the present invention, an aircraft landing gear locking rod or pin comprises a spring loaded actuator linkage, which urges a lock pin assembly in contact with a bushing, wherein the locking rod or pin is in an engaged position for holding a rotating portion of the landing gear in fixed relationship to a non-rotating portion of the landing gear. In response to an excessive side (lateral) load on the landing gear, and in excess of a predetermined threshold level, the locking rod or pin is automatically released. The lock rod or pin assembly is expelled from the bushing and the rotating portion is free to rotate. The threshold load level is determined as a function of the spring force applied to the lock rod or pin assembly via the actuator linkage.

The present invention represents a significant improvement over the prior art because the rotation of the nose gear wheel is prevented from turning at extreme angles or angles that would cause damage to the aircraft from the connection apparatus to the tug tow vehicle. When unlocked, however, the nose gear operates in a conventional manner. In another aspect, the invention represents an improvement in that the locking rod or pin can be repositioned to the released position in response to excessive side load levels. The locking rod or pin device of the present invention does not use a breaking pin and therefore avoids the repair and aircraft down time that is required for breaking pin replacement after failure.

The foregoing and other objects, features, and advantages of the present invention will become more apparent in light of the following Detailed Description of exemplary embodiments thereof, as illustrated in the accompanying drawings. Thus, the invention also comprises adding optional structural or design features to those described throughout this disclosure. Exemplary embodiments of the present invention that are shown in the drawings and are summarized here are for illustrative purposes only. These and other embodiments are more fully described in the Detailed Description section. It is to be understood, however, that there is no intention to limit the invention to the forms or aspects of the invention specifically described in this Summary of the Invention or in the Detailed Description. One skilled in the art can recognize that there are numerous modifications, equivalents and alternative constructions that fall within the spirit and scope of the invention as expressed in the claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings.

FIG. 1 is an illustration of a front view of an exemplary landing gear with locking control device in open or unlocked position.

FIG. 2 is an illustration of a front view of an exemplary landing gear with front tire turned, showing another view of locking control device in open or unlocked position.

FIG. 3 is an illustration of a front view of an exemplary landing gear with locking control device in the locked position.

FIG. 4 is an illustration of side view of an aircraft and nose gear with the locking control device in the locked position.

FIG. 5 is an illustration top view of an aircraft and nose gear.

FIG. 6 is an illustration top view of an aircraft and nose gear with tire turned to side.

FIG. 7 is an illustration a front view of an aircraft and nose gear with tire turned to side.

FIG. 8 is a close up illustration of the locking device in combination with nose gear. The locking device is in the unlocked position.

FIG. 9 is an illustration of a front view of an exemplary landing gear with locking control device in open or unlocked position.

FIG. 10 is an exploded view of an exemplary locking pin for use as a locking element in the locking device.

FIG. 11 is a close-up view of the rotating hand lever.

FIG. 12 is a close-up view of the locking device in a locked position.

FIG. 13 is a cutaway view of dual locking pins used as a locking element.

### DETAILED DESCRIPTION OF THE INVENTION

The invention includes or can be implemented with an aircraft front or nose landing gear assembly. One of ordinary skill in the art will understand the general structure, function, and capability of a nose gear assembly, and text and explanations here refer to generally known or available aspects of landing gear only to the extent necessary to understand the invention or its advantages. The landing gear assembly is comprised of a conventional shaft member connecting to a U-shaped fork 2 device to hold the tire or wheel 1. The shaft can have one or more shock and/or vibration dampening devices or elements at higher regions, above the tire end and connected through the main shaft of the landing gear. An upper shaft section of the landing gear device of the invention is generally rotationally fixed and does not rotate with steering input or with the front nose wheel 1 when turned side to side. In addition, the nose landing gear assembly comprises steering mechanisms, such as a steering collar and steering control tubes or connectors for controlling the direction of the wheel while taxiing. The steering mechanisms are generally at the upper or aircraft end of shaft member rather than the lower or tire end.

Referring now to the drawings, where like or similar elements are designated with identical reference numerals throughout the several views, a preferred embodiment of a locking nose gear system or device of the invention is depicted. Additional embodiments and alternative elements for performing the objectives of the parts and devices shown can be designed and used by one of ordinary skill in the art.

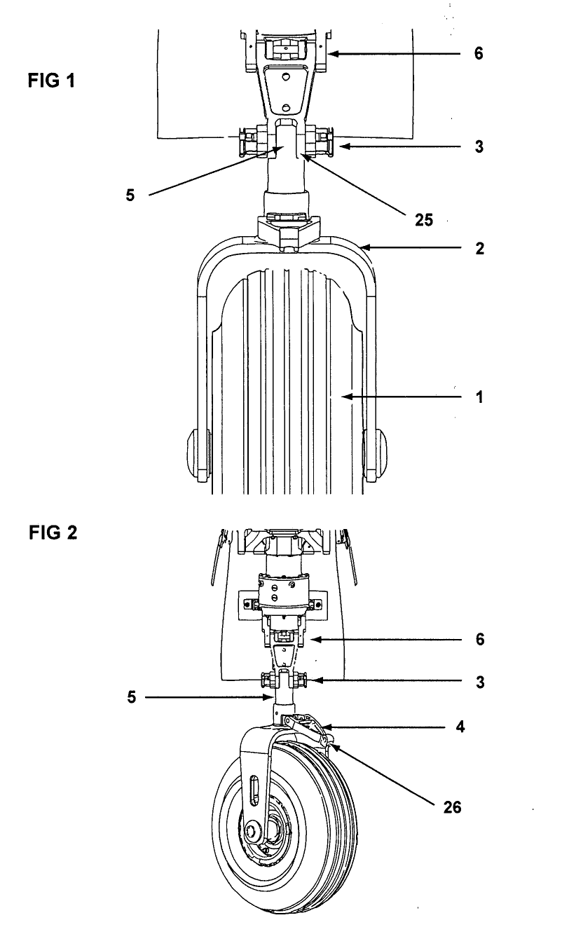

Referring in particular to FIG. 1 and FIG. 2, the locking device of the invention comprises an upper connection arm region 6, the connection arm 6 attached to the upper shaft by a strut, cylindrical sleeve, or other attachment device. The connection arm 6 can be rotationally locked and supported by the upper shaft to withstand rotational pressure, or withstand rotational pressure when the locking device is in a locked position. An extending portion 25 of the arm 6 has a locking device 3, here shown as opposing rods 28 connected to knob of locking device 3 (see FIG. 10). A gap region 5 between the opposing locking rods can receive lock ball 26 when placed into position, where lock ball 4 has an open structure to securely receive opposing rods 28. As shown in FIG. 2, the ball region 26 of control lock arm 4 can be positioned into gap 5 only when tire 1 is configured in straight or non-turning position. However, additional embodiments can allow arm 6 to rotate so that when a straight or non-turning position is reached, arm 6 moves into a locked position when engaged by rods into ball 26 of control lock arm 4. Thus, the wheel 1 does not necessarily have to be positioned in a completely straight or non-turning position in order to engage rods 28 into ball 26 or control lock arm 4. Generally, control lock arm 4 is connected to the lower end or wheel end of the nose gear assembly and can freely rotate with the wheel when in an unlocked position. While rods are depicted to engage into ball 26 in arm 6, tenons or pins or other structures can be used. Once the control lock arm 4 is engaged, the rotational freedom of wheel 1 is restricted or even prevented from leaving straight-forward orientation. Aircraft parts, such as the landing gear hatch cover, cannot be damaged during tug tow operations, for example.

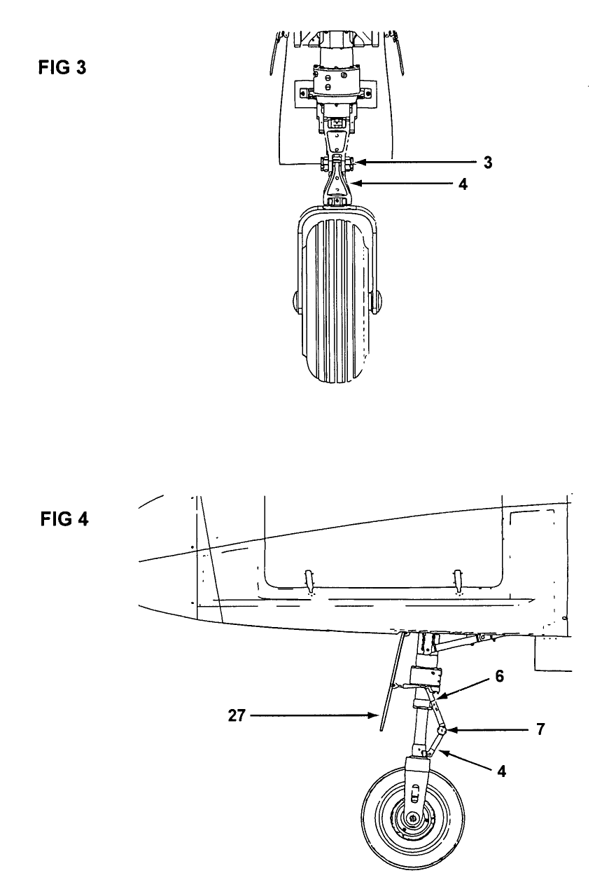

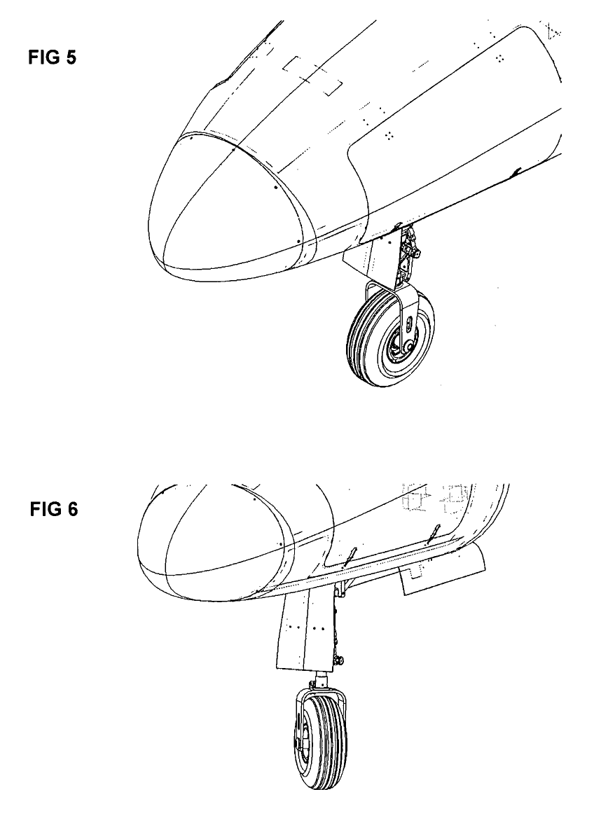

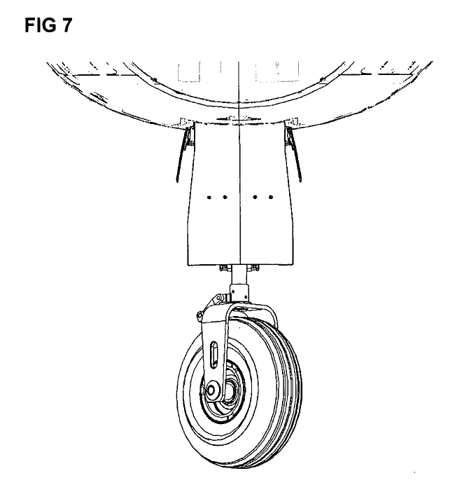

FIG. 3 shows control lock arm 4 engaged within the gap region 5 and the tire set into a straight-forward orientation. FIG. 4 shows the control lock arm 4 in engaged position 7.

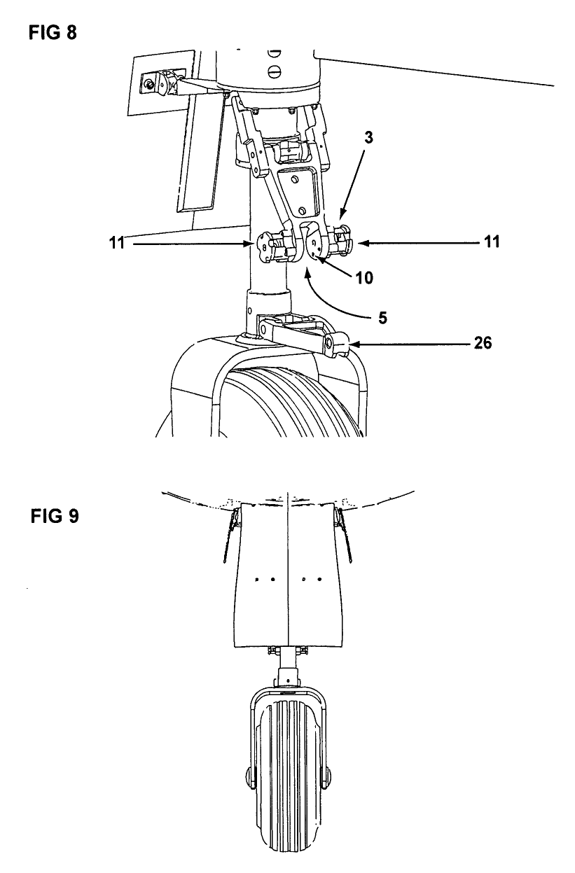

FIG. 8 depicts the device in an unlocked position. Control lock arm 4 is in downward position and can pivot up. Gap region 5 is visible. Knobs 11 in locking device 3 are also in an unlocked position. Rods 28 (not visible) within knobs of locking device 3 can be placed into locking position by rotating knobs 11 into locking position, whereby rods 28 extend through holes 10 at the interior surface. Various lock-indicating designs can be incorporated, such as brightly colored faces on internal elements that disappear when the knob is turned into the locking position. Brightly colored faces of ball region 26 or control lock arm 4 can be visible only when in a locked or unlocked position, or a locking indicator within ball 26 can be actuated only when rods 28 are correctly locked inside ball region 26. A cockpit hatch or viewport for the nose landing gear can be used to confirm the locked or unlocked position.

FIG. 10 depicts exemplary parts to knob 11. In this example, the rod 28 is under tension by spring 23 in housing 22 and against fixed position gasket 24. Extending elements in turning handle 21 actuate rod 28 and send it into locking position. Fastener 20 holds handle 21 and housing 22 together, and housing 22 can be fastened to arm 6 by an internal screw face (not shown).

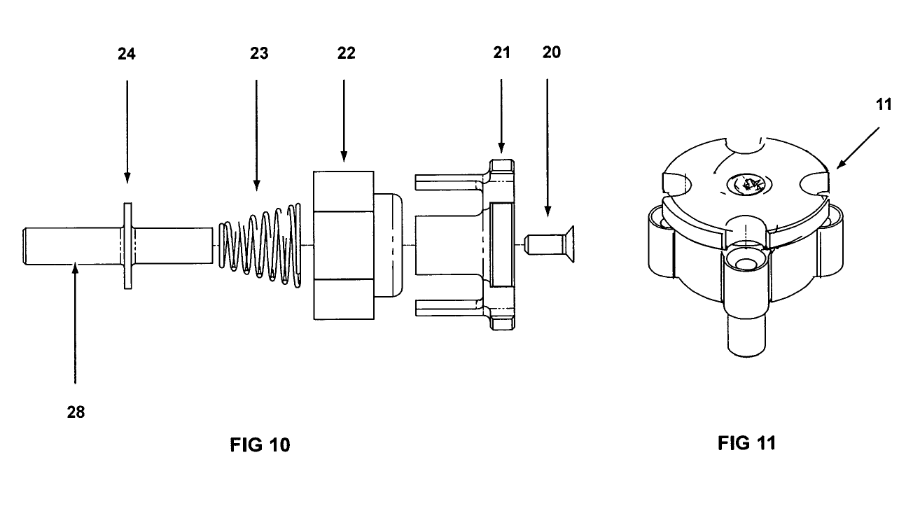

An alternate knob 11 is shown in FIG. 11, where extending elements bias the device and knob to the unlocked position by springs (not shown) and turning outer dial of knob forces extending elements down to engage rod 24 into control lock arm 4. Various examples of this type of known design can be configured. In one optional example, the force of spring 23 can be selected so that lateral pressure on the device, such as at the junction between ball 26 and the interior surface of control lock 4, can automatically release rod 28 to prevent damage to the connection apparatus to the tow tug vehicle. Similarly, pressure sensors on the ball 26 and the interior surface of control lock 4 can trip an alarm.

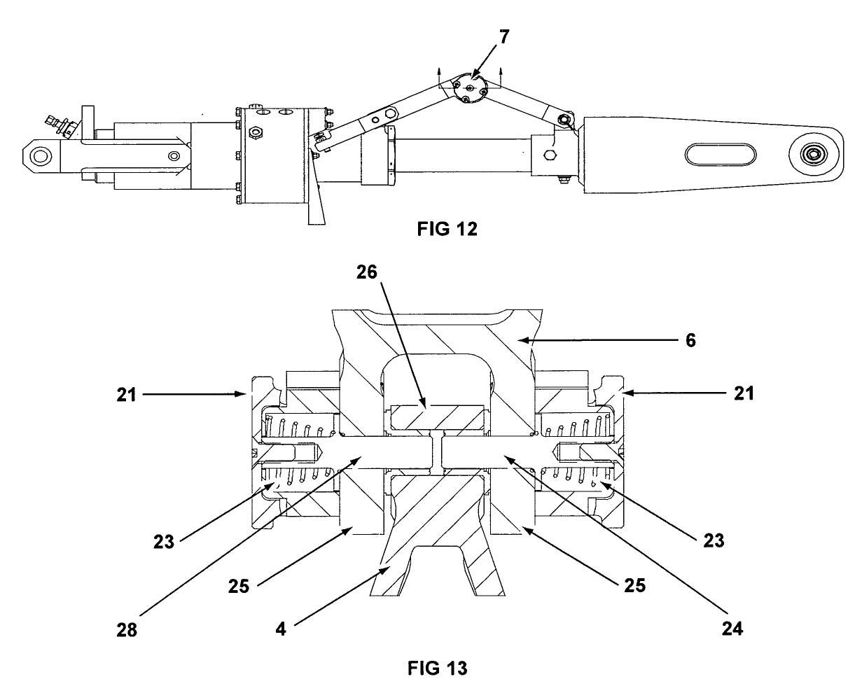

FIG. 12 depicts a close-up view of locked position 7.

FIG. 13 depicts a cutaway view of opposing rods 24 engaged into ball region 26 of control lock arm 4. Handle 21 has been turned to set rod 24 into lock position, where each side locks into the mortise area of ball 26 in control lock 4.

Of course, the exemplified features (rods, mortise receiving ball region, lock arms, etc.) are merely examples and many other features or elements can be added to each the same safety locking effect of the engaged device on nose landing gear. Furthermore, the design or particular shape of the elements described here are merely exemplary and other designs or shapes can perform the same function. One of skill in the art will thus recognize that multiple combinations of elements or parts can be fabricated for the design or specifications of a number of different aircraft or landing gear. Accordingly, there is no intention to limit the invention to the disclosed exemplary forms. Many variations, modifications and alternative constructions fall within the scope and spirit of the disclosed invention as expressed in the claims.

What is claimed is:

1. An aircraft landing gear orientation locking device to restrict rotational freedom of a nose landing gear having an upper region and a lower wheel region, the lower wheel region including a nose gear wheel, the device comprising an upper shaft connection arm operably connected to the upper region of the nose landing gear and capable of being locked to restrict or prevent rotational movement of the upper shaft connection arm relative to the upper region of the nose landing gear, a wheel region control locking arm capable of being positioned to engage the upper shaft connection arm, and a locking element to lock the control locking arm to the upper shaft connection arm, whereby the rotational freedom of the nose gear wheel is restricted when the locking element locks the control locking arm into the upper shaft connection arm.

2. The locking device of claim 1, wherein the control locking arm is pivotably connected to the lower wheel region of the nose landing gear and can freely rotate with the rotation of the nose gear wheel.

3. The locking device of claim 1, wherein the locking element comprises two rods that connect the upper shaft connection arm to the control locking arm.

4. The locking device of claim 1, wherein a spring biases the locking element in a locked position.

5. The locking device of claim 3, wherein a spring biases the locking element in a locked position.

6. The locking device of claim 3, wherein a hand actuated knob moves the rods from a locked position to an unlocked position.

7. The locking device of claim 1, wherein a visible appearance of surfaces displayed with the locking device in a locked position differs from a visual appearance of surfaces displayed with the locking device in an unlocked position.

8. The locking device of claim 7, wherein the difference in surfaces displayed comprises a difference in colored surfaces visible.

9. The locking device of claim 1, wherein lateral pressure against the locking device when in a locked position can be detected by a sensor.

10. The device of claim 1, wherein the upper shaft connection arm is fixed in a rotationally fixed orientation relative to the nose gear wheel.

11. The device of claim 1, wherein the upper shaft connection arm can be slidably lowered into a rotationally fixed orientation relative to the nose gear wheel.

12. The device of claim 1, wherein a degree of rotational freedom of the nose gear wheel with the locking device in a locked position is about 5 degrees or less.

13. The device of claim 12, wherein the degree of rotational freedom of the nose gear wheel with the locking device in the locked position is about 2 degrees or less.

14. The device of claim 1, wherein the upper shaft connection arm is connected around the upper region of the nose landing gear by a cylindrical element.

15. The device of claim 1, wherein the control lock arm is connected to the wheel region of the nose landing gear by a cylindrical element.

16. An aircraft landing gear assembly comprising at least one locking device as claimed in claim 1.

17. An aircraft landing gear assembly comprising two or more locking devices as claimed in claim 1.

18. A locking aircraft landing gear comprising a locking assembly for controlling the rotational degrees of movement allowed for the landing gear wheel, the assembly comprising a pivoting control arm extending from a lower region of the landing gear, a connection arm supported by an upper shaft region of the landing gear, and a control lock for locking the control arm to the connection arm, the control lock positioned on either the connection arm or control arm and capable of withstanding rotational pressure to prevent the landing gear wheel from turning more than a desired degree of rotation.

19. The locking aircraft landing gear comprising a locking assembly as claimed in claim 18, wherein control lock comprises a spring and rod assembly for temporarily locking the control arm to the connection arm.
